(19) United States
(12) Patent Application Publication
(10) Pub. No.: US 2008/0256065 A1
(43) Pub. Date: Oct. 16, 2008

(54) Information Extraction System

(76) Inventor: Jonathan Baxter, Ashburn, VA (US)

Correspondence Address: ROBERT PLATT BELL;REGISTERED PATENT ATTORNEY, P.O. BOX 13165, Jekyll Island, GA, 31527, US

(21) Appl. No.: 12/089,381

(22) PCT Filed: Oct. 13, 2006
(86) PCT No.: PCT/AU06/01512

§ 371 Date: Apr. 4, 2008

(30) Foreign Application Priority Data
Oct. 14, 2005 (AU) 2005905675

(51) Int. Cl. G06F 17/30; G06F 7/00

(52) U.S. Cl. 707/5; 707/E17.108

(57) ABSTRACT

A method for determining link feature weights from a data set of linked elements is described. These link feature weights are indicative of whether a link travels to a subset of the data set, which has a predetermined characteristic. The link features weights also correspond to link features associated with links between the linked elements of the data set. The method comprises the steps of first choosing the link features in accordance with the predetermined characteristic of the subset and then determining the link feature weights based on evaluating a measure that the link travels towards the subset. In one embodiment, the link feature weights are utilized in a web crawler for crawling web pages to extract information such as biography pages and the like.

### CROSS-REFERENCE TO RELATED APPLICATIONS

The present application is a §371 National Phase Application of International Application PCT/AU2006/001512, filed on Oct. 13, 2006, which in turns claims priority from Australian Provisional Patent Application No. 2005905675 entitled “Information Extraction System,” and filed on 14 Oct. 2005; both of which are hereby incorporated by reference in their entirety.

### FIELD OF THE INVENTION

The present invention relates to a machine learning system for information extraction from a data set. In one particular form, the present invention relates to a method for facilitating the crawling of websites to find specific kinds of pages, such as executive biography pages.

### BACKGROUND OF THE INVENTION

There are two broad categories of Internet search-engines currently in use to find and identify information located on the Internet such as web pages and the like. The first of these categories involves generic search engines that attempt to index large portions of the web whilst the second category includes topic-specific search engines that index only specific kinds of documents, such as executive biography pages from corporate websites, or product pages from e-commerce websites.

Generic search engines do relatively little processing of the pages they index; usually the words on the page, incoming link text and a few more easily computed features. Consequently they only support generic, unstructured queries such as locating pages that contain one or more search terms. Topic-specific search engines usually do considerably more processing of the pages they index in order to extract structured records that can be queried with a more sophisticated query language. For example, a topic-specific search-engine processing executive biography pages would segment the individual biographies from the page, extract the names and job titles from the biographies, and build a search index or database that enables querying on name or job title.

To collect the data for a topic-specific search engine a crawler is typically seeded with the home pages of the sites of interest (e.g., the .com domains). It then crawls those domains looking for the specific pages that relate to the topic of interest. The crawler operates by first crawling the home page and extracting and queuing the links from that page. It then iteratively crawls the destination pages of the queued links, extracting and queuing the links from each destination page, and so on.

To reduce processing and bandwidth requirements, it is important to crawl as few pages as possible whilst ensuring that the relevant pages of interest are collected. One approach to the problem is to assign a score to each link as it is extracted, and to crawl the links in descending score order. Scores may be assigned heuristically, based on features associated with the extracted links. For example, the link:
http://www.madderns.com.au/people/peop_anthony.htm
   contains features such as “people” in the path of the destination uniform resource locator (URL), and a first name and last name in the link text, this being determined by automatic lookup in a first name and a last name dictionary. A heuristic algorithm would then assign a high score to links containing such indicative features.

One problem with assigning scores heuristically in this manner is that websites vary a great deal in structure and as such, heuristics that work for one site may not work for others. For example, a site may use the term “management” instead of “people” in the path and may list all management biographies on the same page so there are no first name or last name features. In addition, heuristics that are effective for locating one kind of page will not be effective for locating different kinds of pages. For example, features useful for locating management team pages would not be effective for locating employment pages.

A second problem is that while it is relatively easy to invent features that lead directly to the pages of interest for a given topic, such as the case above, it is more difficult to invent features that are indicative of links that are further removed. These are links that link to pages that themselves link to the pages of interest. And furthermore links that link to pages that link to pages that themselves link to the pages of interest and so on. If the pages of interest are not directly linked to from the home page of a website, it is still important that the crawler be directed down the most promising series of links so as not to waste bandwidth and processing power.

### SUMMARY OF THE INVENTION

It is an object of the present invention to provide a method to facilitate the ability of a crawler to crawl linked elements in a data set to find elements of interest.

In a first aspect the present method accordingly provides a method for determining link feature weights from a data set of linked elements, the link feature weights indicative of whether a link travels to a subset of the data set, the subset having a predetermined characteristic, the link feature weights corresponding to link features associated with links between the linked elements of the data set, the method comprising the steps of: choosing the link features in accordance with the predetermined characteristic of the subset; and determining the link feature weights based on evaluating a measure that the link travels towards the subset.

Once link feature weights have been determined in this manner then they may be employed in a crawling method to crawl other data sets of linked elements to find in each of these subsets, elements that have the predetermined characteristic which is of interest. By associating the link feature weights with a measure that corresponds to whether a link travels towards this subset, these link feature weights once determined on the “training” data set will then generalize to other data sets and can be used alone or in combination with many standard crawling techniques to seek the elements of interest.

Preferably, the measure that the link travels towards the subset is based on evaluating a random walk throughout the linked elements of the data set.

Preferably, the step of evaluating a random walk throughout the linked elements of the data set comprises estimating a proportion of time the random walk spends in the subset.

Preferably, the step of determining the link feature weights comprises varying the link feature weights to optimize the measure to increase the proportion of time that the random walk spends in the subset.

Preferably, the step of varying the link feature weights to optimize the measure comprises determining a derivative of the measure as a function of the link feature weights.

Preferably, the step of varying the link feature weights to optimize the measure comprises adopting a gradient ascent approach.

Preferably, the evaluating of the random walk is adapted to ensure that there is a unique stationary distribution over the linked elements of the linked data set.

Preferably, the evaluating of the random walk is further adapted to increase a convergence rate of the random walk to the unique stationary distribution.

Preferably, the convergence rate is increased by introducing a uniform jump probability between linked elements in the data set in the evaluating of the random walk.

Preferably, the link features further comprise source element features characteristic of a source element from which a link originates.

Preferably, the method further comprises adding a free link to the linked elements of the data set, the free link originating from each of the linked elements and linking to a non-target element.

In a second aspect the present invention accordingly provides a method for determining link feature weights from a plurality of data sets of linked elements, the link feature weights indicative of whether a link travels to subsets in each of the plurality of data sets, the subsets each having a common predetermined characteristic, the link feature weights corresponding to link features associated with links between the linked elements of each of the plurality of data sets, the method comprising the steps of: choosing the link features in accordance with the common predetermined characteristic of the subsets; and determining the link feature weights based on a plurality of measures evaluated for each of the plurality of data sets, wherein an individual measure for an individual data set indicates that the link travels towards a corresponding subset in the individual data set.

Preferably, the individual measure is based on evaluating a random walk throughout the linked elements of the individual data set.

Preferably, the step of evaluating a random walk throughout the linked elements of the individual data set comprises estimating a proportion of time the random walk spends in the corresponding subset.

Preferably, the step of determining the link feature weights comprises varying the link feature weights to optimize the plurality of measures to increase the proportion of time that the random walk spends in the corresponding subset of the individual data set.

Preferably, the step of varying the link feature weights to optimize the plurality of measures comprises forming a combined measure as the sum of the plurality of measures.

Preferably, the step of varying the link feature weights to optimize the plurality of measures further comprises determining a derivative of the combined measure as a function of the link feature weights.

In a third aspect the present invention accordingly provides a method for crawling linked elements in a data set to find a subset having a predetermined characteristic, the method comprising the steps of: evaluating link feature weights corresponding to link features between linked elements in the data set, the link feature weights determined by evaluating a measure on at least one training data set that a link travels towards a corresponding subset having the predetermined characteristic in the at least one training data set; ranking links between linked elements in the data set according to the evaluated link feature weights; and crawling preferentially along the links of highest rank.

Preferably, the measure is based on evaluating a random walk throughout linked elements in the at least one training data set.

Preferably, the step of ranking links comprises determining a link ranking score proportional to the sum of the evaluated link feature weights.

Preferably, the method further comprises recording a crawled set of elements corresponding to the elements crawled so far, and wherein the step of crawling only travels down links to destination elements that are not members of the crawled set.

Preferably, the method further comprises terminating the crawling step after a predetermined number of elements have been crawled.

Preferably, the step of crawling comprises traveling down a link having the highest link ranking score from outgoing links from a currently occupied element.

Optionally, the step of crawling comprises traveling down a link having the highest ranking score amongst outgoing links from all previously crawled elements.

Optionally, the step of crawling further comprises selecting a link non-uniformly at random from amongst outgoing links from all previously crawled elements, wherein the probability of selecting a link is monotonically related to its link ranking score.

Preferably, the method further comprises periodically selecting a random link to be crawled.

Preferably, the method further comprises applying an automatic classifier trained to recognize target elements of interest, and storing only those elements that are positively classified.

Preferably, the method further comprises terminating the crawling step if a predetermined number of non-target elements are crawled sequentially

### BRIEF DESCRIPTION OF THE DRAWINGS

A number of embodiments of the present invention will now be discussed with reference to the accompanying drawings wherein:

FIG. 1 is a schematic diagram of a generic web site employed to determine link feature weights from a data set of linked elements in accordance with a first embodiment of the present invention;

FIG. 2 is a schematic diagram of a directed graph G equivalent in structure to the website illustrated in FIG. 1;

FIG. 3 is a flowchart of a method for determining link feature weights from a data set of linked elements according to a first embodiment of the invention;

FIG. 4 is a schematic diagram of a series of websites and equivalent directed graphs Gₙ employed to determine link feature weights from multiple data sets according to a second embodiment of the present invention;

FIG. 5 is a flowchart of a method for determining link feature weights from multiple data sets according to a second embodiment of the present invention; and

FIG. 6 is a flowchart of a method for crawling linked elements in a data set according to a third embodiment of the present invention.

In the following description, like reference characters designate like or corresponding parts throughout the several views of the drawings.

### DETAILED DESCRIPTION OF THE INVENTION

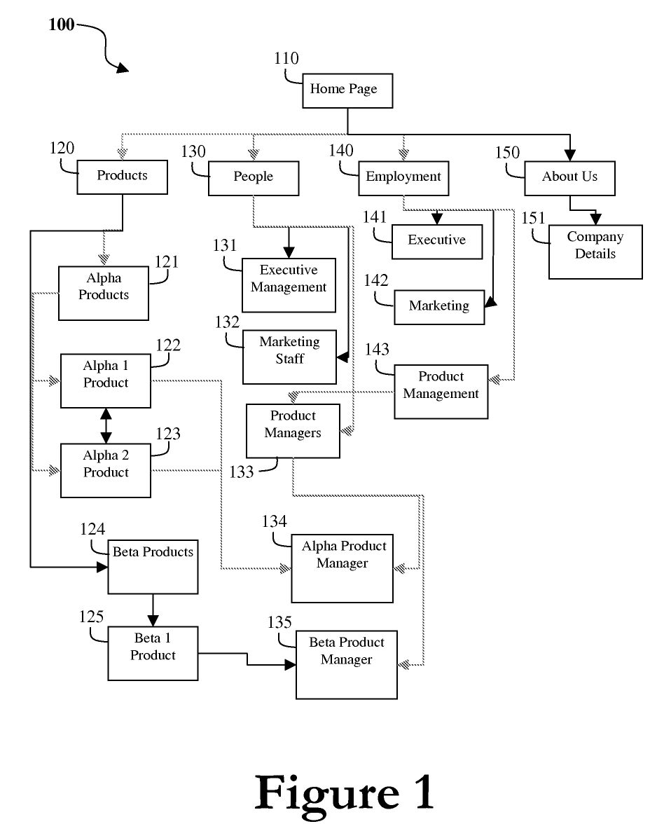

Referring now to FIG. 1, there is shown a schematic view of a web site 100 including a number of linked pages. As referred to previously, a common searching task performed on web sites is the location of pages having a predetermined characteristic such as being a biography page or a product page. As an illustrative example, the pages of interest for web site 100 may be the alpha product manager page 134 and beta product manager page 135, these pages being examples of biography pages that relate to product managers, which may be targeted for a particular recruitment task.

Although the present invention is to be described with reference to generic web site 100, it will be appreciated by those skilled in the art that the present invention may be applied to web sites having widely varying linkage structures. Furthermore, the present invention may be applied in general to any set of linked elements in a data set to determine link feature weights that then facilitate the extraction of subsets in other unseen data sets that have a predetermined characteristic associated with the link features chosen.

In this illustrative example of a data set containing linked elements, web site 100 includes a home page 110 linked in turn to four top level category pages consisting of a “products” page 120, a “people” page 130, an “employment” page 140 and an “about us” page 150. Each of these pages is in turn linked to further pages. In this example, the pages of interest are product manager pages 134, 135. An iterative crawler as known in the prior art, would exhaustively crawl all the pages in web site 100 to be certain that it has found all the pages of interest. This includes traveling down all the potential links between pages. As is common, there may be multiple linkage paths to a page of interest. For example, to reach page 134 from the home page 110 the linkage paths include:
110→120→121→122→134
110→120→121→123→134
110→130→133→134
110→140→143→133→134

Whilst in this illustrative example, the difference in the number of links that must be traversed between an optimal and a non-optimal route is small (i.e., 1 link) it would be appreciated by those skilled in the art that there may be extremely large differences between these routes. As stated previously, not only will an iterative crawler have to exhaustively crawl every link in website 100, furthermore the crawler cannot take advantage of optimal versus non-optimal routes in order to travel to those pages of interest. Obviously, this will significantly affect the amount of time taken to identify and extract information from a website.

A first embodiment of the present invention will now be discussed with reference to web site 100. Whilst this first embodiment is directed to the problem of determining link feature weights which are indicative of whether a link travels to a given web page or pages in a website it will be appreciated by those skilled in the art that other applications, which are consistent with the principles described in the specification are also contemplated to be within the scope of the invention.

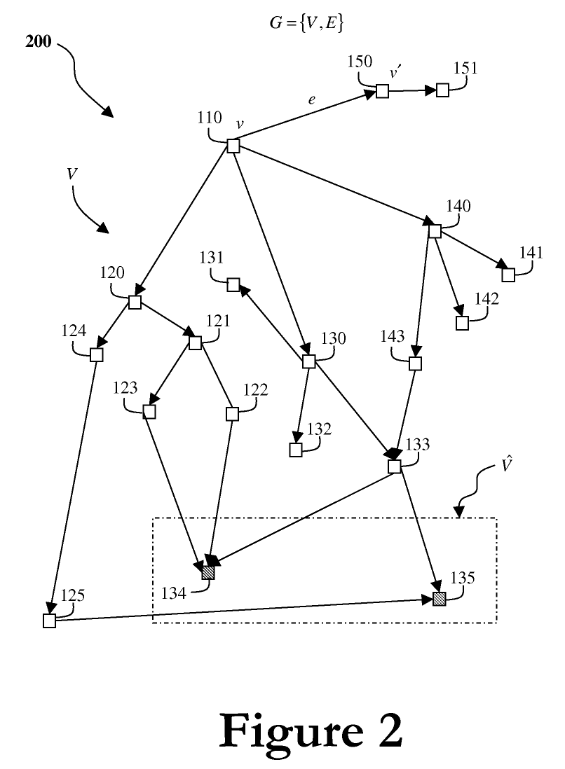

At this stage it is appropriate to adopt the mathematical formalism of a directed graph G (as seen in FIG. 2) to discuss the present invention in its application to determining link feature weights, as this will greatly simplify the description. Note that in the following description the terms graph G, vertex v and edge e will be used interchangeably with the corresponding or equivalent terms website, web page and link where appropriate.

Referring now to FIG. 2, there is shown a directed graph G={V, E} 200 equivalent in structure to web site 100. In principle, any data set containing linked elements can be mapped to an equivalent directed graph G. Directed graph G includes a vertex set V={1, . . . , n} corresponding to web pages

{110,120,121, . . . , 125,130, . . . , 135,140, . . . , 143,150,151}

as illustrated in FIG. 1.

Edge set E corresponds to the links between vertices and is defined as including edges e:v→v′ which denote an edge from vertex v to vertex v′ (there may be more than one), and edges e:v→ to denote any outgoing edge from v (regardless of destination vertex). As can be readily determined by inspection, web site 100 is equivalent to directed graph G 200 where the edge set E corresponds to the links between pages. Note that in principle there may be more than one edge between any pair of vertices, reflecting the fact that there may be more than one link between any pair of web pages in a website.

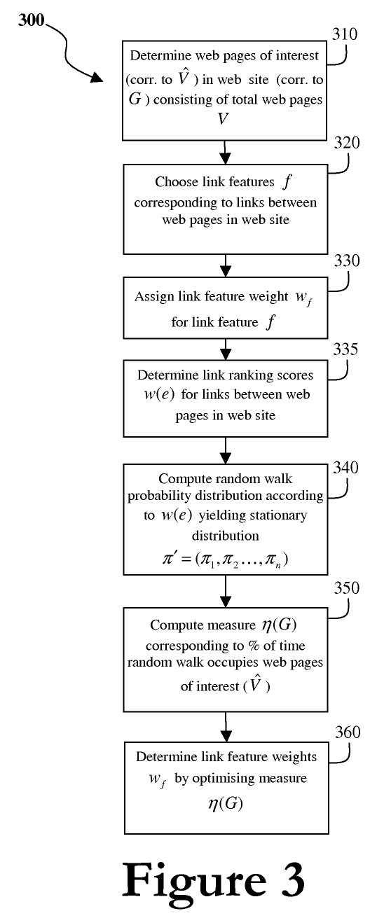

Referring now to FIG. 3, there is depicted a flowchart of the method 300 for determining link feature weights in a data set (e.g., website) of linked elements (e.g., web pages) according to a first embodiment of the present invention. At step 310, the web pages of interest are first determined, these corresponding to the subset of the dataset having a predetermined characteristic. In the example of web site 100 illustrated in FIG. 1, the web pages being sought to be extracted are the product manager pages 134 and 135. As illustrated in FIG. 2, these pages correspond to \hat{V}, as this is the subset of vertices V (i.e., \hat{V}⊂V) that corresponds to the pages of interest.

At step 320, link features are identified for links between web pages or as stated more formally for any edge eεE, let f(e) denote at least one link feature associated with edge e. The features may be real or Boolean-valued, but in this first embodiment they are defined to be Boolean, such that f(e)=1 if edge e (or equivalently link) has feature f, and conversely f(e)=0 if edge e does not have feature f. Let F={f} denote the set of all features on all edges. Edge or link features are chosen in accordance with the \hat{V}⊂V that correspond to the pages of interest or those pages having a predetermined characteristic such as being “product manager” pages as is the case here.

Some examples of relevant link features that may be useful to identify their eventual destination in this example include:
features indicating words in link text (e.g., the text “product”, “management”, or “team”);
features indicating the presence of broad categories of words in the link text, such as presence in a first_name or last_name list, or features indicating lead_capitalization;
features of the destination URL path, such as the path elements path_people, or character n-grams of the path ngram_peop, ngram_eopl, ngram_ople, etc. (the n-gram features will to some extent alleviate the problem of abbreviation used in URL path or query components).

As would be appreciated by those skilled in the art, the step of choosing link features will be based on the characteristics of the web pages that are being sought. In this respect, link features that have been known to perform adequately in prior art heuristic algorithms may be employed as an initial starting point.

At step 330, to each link feature fεF assign a real number (“link feature weight”) w_{f} which in principle will reflect the importance of that feature in determining whether that link will travel towards a web page of interest.

At step 335, define link ranking score w(e) to denote the sum of all weights on the active features associated with edge e:

$$w ( e ) = {\sum }_{f ∈ F} {w}_{f} f ( e ) . \qquad ( 1 )$$

At step 340, a random walk on the graph G is computed based on the link ranking scores and involves the following steps:
1. choose a vertex vεV uniformly at random, this being equivalent to randomly choosing a web page in web site 100
2. compute the distribution p_{v,v′} over destination vertices v′εV as follows:

$${p}_{v , {v}^{′}} = \frac{{\sum }_{e : v -> {v}^{′}} {e}^{w ( e )}}{{\sum }_{e : v ->} {e}^{w ( e )}} \qquad ( 2 )$$

where it follows that for each vertex v, p_{v,v′} is a probability distribution over the destination vertices v′
3. jump to vertex v with probability p_{v,v′}
4. replace v with v′ goto 2.

Although in this first embodiment, the edge probabilities are modeled as an exponential function of a linear combination of the edge features, it would be apparent to those skilled in the art that other parameterizations of edge probabilities that are differentiable functions of the parameters will also suffice. One such example is a neural network parameterization.

This random walk process results in the generation of a vertex probability distribution over the vertices of the graph G, where the probability of each vertex is the proportion of time the walk spends in that vertex. As a general principle, the vertex probability distribution could be a function of the starting vertex chosen in step 1 (for example, if the starting vertex only links to itself, then the random walk will forever remain in the starting vertex). However, step 3 of the method may be modified to include a probability ε of uniformly jumping to any other vertex, thereby ensuring that the vertex probability distribution is independent of the starting vertex. This then ensures that the vertex probability distribution will be unique as a general consequence of Markov chain theory.

Accordingly, modified step 3 is defined to be:

3′. jump to vertex v′ with probability

$${p}_{v , {v}^{′}}^{ɛ} = ( 1 - ɛ ) {p}_{v , {v}^{′}} + \frac{ɛ}{n} . \qquad ( 3 )$$

The resultant vertex distribution is then a unique stationary distribution and is denoted by π:

π′=(π₁,π₂, . . . , πₙ) (4)

where πᵢ is the stationary probability of vertex i, or equivalently, the proportion of time the random walk spends in vertex i (recall that there are n vertices). As used herein, the prime symbol is used to denote transpose, so π is a column vector and π′ is a row vector.

Whilst in this embodiment, the strategy of jumping uniformly at random to any other vertex is adopted for ensuring that the random walk has a unique stationary distribution there are a number of other approaches that may be applicable. In the context of crawling web pages, one approach may be to jump uniformly to another web page with probability ε₁, follow each outgoing edge uniformly with some other probability ε₂ and uniformly jump back to the home page with some probability ε₃. The remainder of the time (i.e., with probability 1−(ε₁+ε₂+ε₃)) link formula (2) is followed.

Defining P to denote the transition probability matrix of original probabilities p_{v,v′} then

P=[p_{v,v′}]_{v,v′=1 . . . n}, (5)

If P_{ε} then denotes the transition probability matrix as modified by the uniform jump probability ε then accordingly

$${P}_{ɛ} = {[ {p}_{v , {v}^{′}}^{ɛ } ]}_{v , {v}^{′} = 1 … n} = ( 1 - ɛ ) P + \frac{ɛ}{n} 1 , \qquad ( 6 )$$

where 1 is the n×n matrix with a one in every location.

As a website may contain several thousand or more pages, the matrix P_{ε} may have dimensions of several thousand and, as is well appreciated in the art, the associated computational overhead in calculating matrices of this order is potentially very high. However, although P_{ε} is dense (there is at least a minimum probability ε/n of any transition), equation (6) shows that if the underlying graph is sparse (has few edges) then P_{ε} is a linear combination of a sparse matrix P=[p_{v,v′}] and a uniform matrix ε/n, the latter of which may be represented by a single number. As can be readily seen, this then represents significant savings both in space and complexity, as only the non-zero elements p_{v,v′}≠0 participate in computations and require storage.

Additionally, for a website, P will usually be sparse as most pages in a large website contain links to only a small fraction of other pages on the website thereby reducing computational overhead. P_{ε} satisfies

π′P_{ε}=π′, (7)

as π is defined to be the stationary distribution of P_{ε} and

P_{ε}e=e, (8)

where e′ (1, . . . , 1) is the vector of all ones. This relationship holds because P_{ε} is a stochastic matrix with row sums of one.

Now as referred to earlier, \hat{V}⊂V is the subset of the vertices V, or equivalently the subset of web pages having a predetermined characteristic within a web site. Link feature weights w_{f} are now determined such that the random walk over G or equivalently website 100 spends as much time as possible in the vertices in \hat{V}, and as little time as possible in the rest of the vertices of the graph G, These link feature weights w_{f} may then be used to prioritize links to be followed to get to the subset \hat{V} or equivalently web pages of interest on any unseen website as part of a crawler seeking those pages.

To this end, let r(v)=1 for vε\hat{V} and r(v)=0 otherwise. As a vector over the vertices \hat{V}, r may be written as r′=(r₁, . . . , rₙ). This r(v) indicates whether a vertex is a member of \hat{V} or not. The next task then at step 350 is to define measure η(G) which denotes the proportion of time the random walk on G spends in the vertices vε\hat{V}.

As the random walk follows links proportionally to their link ranking score, for the random walk to spend significant time in \hat{V}, the link ranking scores must be such that higher scoring links are likely to lead or travel towards \hat{V}, and lower scoring links are likely to lead away from \hat{V}. Thus, choosing link feature weights such that the random walk spends maximum time in \hat{V} will generate link ranking scores that indicate which links best travel towards \hat{V}.

Mathematically, the proportion of time the random walk spends in \hat{V} is given by

$$η ( G ) = {π}^{′} r = {\sum }_{i = 1}^{n} {π}_{i} {r}_{i} \qquad ( 9 )$$

where π is the unique stationary distribution of the random walk (4).

At step 360, link feature weights w_{f} are then determined such that the random walk on G spends as much time as possible in the vertices vε\hat{V}, or equivalently, link feature weights w_{f} are determined such that η(G) is maximal. As the stationary distribution over vertices generated by the random walk corresponds to the distribution over web pages generated by a crawler that follows outgoing links from each page with probabilities given by equation (3) then if the link feature parameters w_{f} are varied such that η(G)=π′r is maximal, then a crawler will then accordingly, on average, spend the maximum possible amount of time in the pages of interest.

In this first embodiment, the method employed for varying and determining link feature weights w_{f} such that η(G), the average time spent by the graph traversed in the vertices of interest, is at least locally maximal is via a derivative based approach based on evaluating ∂η(G)/∂w_{f}. In this approach, the derivative is calculated with respect to each link feature weight w_{f} of η(G), and the weights w_{f} are then varied or adjusted in the direction of the gradient. For a small enough weight adjustment, the average time spent in the vertices of interest by a crawler crawling based on these link feature weights w_{f} is then guaranteed to increase.

As would be appreciated by those skilled in the art, any derivative based algorithm may be used to optimize the weights w_{f}, including but not limited to direct gradient ascent, conjugate methods, Gauss-Newton and quasi-Newton. As the random walk has a unique stationary distribution, and as the transition probabilities p_{v,v′} are differentiable functions of the parameters w_{f}, then the gradient of η(G) is guaranteed to exist (see for example discussion in J. Baxter and P. L. Bartlett., “Infinite-Horizon Policy-Gradient Estimation”, Journal of Artificial Intelligence Research, 15:219-250, 2001, herein incorporated by reference in its entirety).

The derivative of η(G) with respect to the weight w_{f} is given by:

$$\begin{matrix}\frac{\partial η ( G )}{\partial {w}_{f}} = \frac{\partial ( {π}^{′} r )}{\partial {w}_{f}} \\ = \frac{\partial {π}^{′}}{\partial {w}_{f}} r \\ ( since r does not depend on the parameters {w}_{f} ) \\ = {π}^{′} {\frac{\partial {P}_{ɛ}}{\partial {w}_{f}} [ I - {P}_{ɛ} + {eπ}^{′} ]}^{- 1} r\end{matrix} \qquad \begin{matrix}( 10 ) \\ \\ \\ ( 11 ) \\ \\ \\ ( 12 )\end{matrix}$$

where P_{ε} is the n×n matrix of transition probabilities p_{v,v′}^{ε} between vertices given by (3),

$$\frac{\partial {P}_{ɛ}}{\partial {w}_{f}}$$

is the matrix of partial derivatives of P_{ε} with respect to the parameter w_{f}

$$\frac{\partial {P}_{ɛ}}{\partial {w}_{f}} = {[ \frac{\partial {p}_{v , {v}^{′}}^{ɛ}}{\partial {w}_{f}} ]}_{v , {v}^{′} = 1 , … , n} , \qquad ( 13 )$$

I is the n×n identity matrix, and eπ′ is the n×n matrix consisting of the stationary distribution π′=(π₁, . . . , πₙ) in each row.

From (1), (2) and (3) it follows that,

$$\begin{matrix}\frac{\partial {p}_{v , {v}^{′}}^{ɛ}}{\partial {w}_{f}} = \frac{1 - ɛ}{n ( v )} [ {\sum }_{e \text{:} v \to {v}^{′}} f ( e ) {e}^{w ( e )} - {p}_{v , {v}^{′}} {\sum }_{{e}^{′} \text{:} v \to } f ( {e}^{′} ) {e}^{w ( {e}^{′} )} ] \\ where & ( 14 ) \\ n ( v ) = {\sum }_{{e}^{′} \text{:} v \to } {e}^{w ( {e}^{′} )} . & ( 15 )\end{matrix}$$

As would be appreciated by those skilled in the art, there are a number of potential computational issues involved in the calculation of the stationary distributions π. From (7), it can be seen that π is the unique left-eigenvector of P_{ε} with eigenvalue 1 (the largest eigenvalue of P_{ε}), and as such may be computed by the power-method as v′P_{ε}^{N} converges exponentially fast to π′ for any non-zero starting vector v as N→∞.

The rate at which v′P_{ε}^{N} converges to π′ will generally be determined by the size of the second-largest eigenvalue of P_{ε}, which in turn is controlled by the uniform jump probability ε. Accordingly, in this embodiment ε is increased resulting in a more rapid convergence of the power method. As it was found that the behavior of the method is relatively insensitive to the exact choice of the random jump probability ε, this value was then set to a relatively large value to ensure that the convergence rate was increased significantly for the stationary distribution and inverse calculations. In this embodiment of the invention, a value of ε=0.15 was found to work well.

To compute π, the uniform vector

$${v}_{0}^{′} = ( \frac{1}{n} , \frac{1}{n} , … , \frac{1}{n} ) \qquad ( 16 )$$

is first defined and then iterated

vₜ₊₁′=vₜ′P_{ε} (17)

until Pvₜ₊₁−vₜP₁≦δ for some small parameter δ. In this embodiment of the invention, adapted to the crawling of websites, a value of 0.0001 for δ was found to perform well.

The decomposition

$${P}_{ɛ} = ( 1 - ɛ ) P + \frac{ɛ}{n} 1$$

ensures that each successive vector-matrix multiplication (17) requires only O(|P|+n) operations where |P| is the number of non-zero elements of P (i.e., the number of edges in the graph).

The next step requires computation of the inverse [I−P_{ε}+eπ′]⁻¹. As is known in the art, the computational cost of a general matrix inverse is O(n³), which will require significant computing resources to compute for a website containing thousands of pages.

In a further embodiment, a variation on the power method is employed to obtain an approximation to the inverse at far lower computational cost. As the column-vector of all ones e is a right-eigenvector of P_{ε} with eigenvalue 1 (8), and as the stationary distribution π′ is a left eigenvector of P_{ε} with eigenvalue 1 (7), it can be verified by induction that

(P_{ε}−eπ′)^{N}=P_{ε}^{N}−eπ′, (18)

### for N≧1.

Thus expanding [I−P_{ε}+eπ′]⁻¹ in its power series results in

$$\begin{matrix}{[ I - {P}_{ɛ} + {eπ}^{′} ]}^{- 1} = I + {\sum }_{N = 1}^{∞} {( {P}_{ɛ} - {eπ}^{′} )}^{N} \\ = I + {\sum }_{N = 1}^{∞} [ {P}_{ɛ}^{N} - {eπ}^{′} ] .\end{matrix} \qquad \begin{matrix}( 19 ) \\ \\ \\ ( 20 )\end{matrix}$$

P_{ε}^{N} then converges exponentially fast to eπ′ (the matrix with the stationary distribution in each row) at a rate controlled by the uniform jump probability ε. Thus P_{ε}^{N}−eπ′ converges to zero exponentially fast, and it follows that a good approximation to [I−P_{ε}+eπ′]⁻¹ is

$${[ I - {P}_{ɛ} + {eπ}^{′} ]}^{- 1} \approx I - \hat{N} {eπ}^{′} + {\sum }_{N = 1}^{\hat{N}} {P}_{ɛ}^{N} \qquad ( 21 )$$

for some suitably large value of \hat{N}.

\hat{N} is chosen such that PP_{ε}^{\hat{N}}−P_{ε}^{\hat{N}-1}P₁≦δ for some small parameter δ where the matrix norm PP₁ is defined as the maximum over all rows i of PP_{ε}^{\hat{N}}(i)−P_{ε}^{\hat{N}-1}(i) P₁ and P_{ε}^{N}(i) denotes the i-th row of P_{ε}^{N}. In this embodiment, it was found that as with the convergence of the stationary distribution π, that δ=0.0001 performs well for the website crawling problem.

The approximation (21) has computational complexity of O(\hat{N}n²) which is considerably smaller (for large ε and hence small \hat{N}) than the O(n³) complexity required by a naive matrix inverse, thereby representing a significant saving in computational effort to calculate the inverse.

The transition probability matrix derivatives

$$\frac{\partial {P}_{ɛ}}{\partial {w}_{f}} = {[ \frac{\partial {p}_{v , {v}^{′}}^{ɛ}}{\partial {w}_{f}} ]}_{v , {v}^{′} = 1 … n}$$

must be computed for each pair of vertices v,v′ and feature f. By equation (14), a feature f only affects the derivative of the transition probabilities p_{v,v′} from a vertex v that has an outgoing edge e containing f. Thus, for graphs with few edges and sparse features (as is the case for the website crawling problem), the matrices of transition probability derivatives will be sparse for most link feature weights w_{f}.

Additional computational improvements that may be implemented in this first embodiment include storing the edge features as an inverted index (that is, a list of the edges containing a feature f is maintained for each feature) as this allows the transition probabilities with non-zero derivative for each feature to be readily determined, yielding a worst-case complexity of the derivative calculation of O(|F∥P|) where |F| is the total number of features on all edges.

In this first embodiment, the expected proportion of time that a random walk spends in the target pages of interest, η(G)=π′r is optimized using the gradient ascent procedure. However, as would be apparent to those skilled in the art, there is a large range of optimization techniques that do not necessarily depend on the existence of derivatives. Optimization techniques such as evolutionary algorithms or simplex methods may be used to maximize η(G) or other measures that depend upon the stationary distribution π, whether these measures are differentiable or not. As these techniques all relate to evaluating a measure that a link travels towards the subset or pages of interest they are also contemplated to be within the scope of the invention.

In a further embodiment, the measure η(G) is defined to be

$$1 / \vert \hat{V} \vert {\sum }_{v ∈ \hat{V}} {[ {π}_{v} - 1 / \vert \hat{V} \vert ]}^{2} ,$$

which again is differentiable as a function of π and has the potential advantage over the performance measure π′r of encouraging the crawler to spend equal time in all target pages. As would be apparent to those of ordinary skill in the art, the exact choice of measure will be determined in part by the crawling problem that the link feature weights w_{f} are to be applied to.

In a further embodiment, source element features may be incorporated into the link features to further take into account that features of the source element from which a link originates may also be useful in determining whether a link from that source element travels to the subset of the data set of linked elements that is of interest. In the context of the linked elements being web pages of a website the source element is the source page of a link.

Accordingly, features of the source page of a link such as its title, Uniform Resource Locator (URL), depth (how many levels from the home page of the website), text surrounding the link, etc may be useful for determining whether the links from a page will travel to the pages of interest. As an example, all links on an executive biography “hub” page (a page that contains links to all the individual executive biographies) should have their score increased for being on such a page, and particularly features of the page title should be indicative of such pages.

In order to incorporate source element or source page features with the standard link features it is necessary to realize that the link feature weights of such source page features have zero gradient with respect to the performance criterion η(G), as may be determined from (14). The gradient is zero because these source page features are associated with every link on the page, and hence cannot be used in a derivative based approach to distinguish which of the links on the source page to follow.

To incorporate these source features, then in one embodiment of the present invention a “free” edge or link from every vertex v in the graph G to a distinguished non-target vertex is added. In the context of crawling a web page the non-target vertex can correspond to the home page of the website. The source page (vertex) features are then applied only to the original edges or links and not the free edge that links to the home page of the website in this embodiment. A constant feature is also added to each edge so that the source page features may be compared against a baseline. Because the source page features which are now incorporated into the link features do not attach to all outgoing edges or links, their corresponding link feature weights now have a non-zero gradient.

In this manner, the source features may be advantageously incorporated or included with standard link features which pertain only to the links and the present invention applied to determine corresponding link feature weights which now will be indicative of whether a link and source page combination will travel to a web page of interest. In the executive biography example it has been found that significant link feature weights were accorded to link features based on source page features such depth (i.e., links from the home page (depth 0) received higher weight) and source page title.

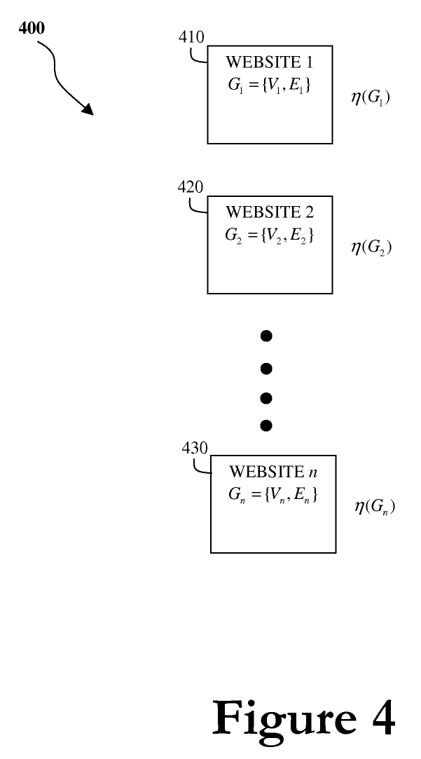

Referring now to FIG. 4, there is shown a schematic diagram of multiple websites 410, 420, 430 or equivalently multiple directed graphs Gₙ which are employed to determine link feature weights w_{f} according to a second embodiment of the present invention. Whilst the previous embodiment optimized the edge or link following behavior for a single graph G using gradient ascent, this approach employs multiple websites or datasets to improve the ability of the determined link feature weights to generally apply to unseen websites having unknown structure with a higher level of statistical confidence.

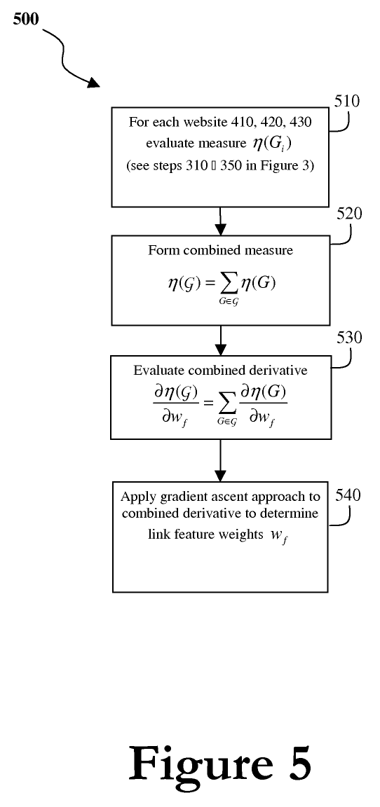

Referring now to FIG. 5, there is shown a flowchart of a method 500 for determining link feature weights in a data set of linked elements according to this second embodiment. As referred to earlier, instead of a single graph G, a collection of graphs G={G₁={V₁,E₁}, . . . , {Gₙ={Vₙ,Eₙ}} that corresponds to multiple websites 410, 420, 430 is employed as a series of data sets from which in combination the link feature weights w_{f} can be determined. At step 510, the measure η(Gᵢ) is first evaluated for each of the multiple websites 410, 420, 430 in accordance with steps 310→350 as referred to in FIG. 3.

At step 520 the combined measure over the collection G is then calculated as

$$n ( 𝒢 ) = {\sum }_{G ∈ 𝒢} η ( G ) . \qquad ( 22 )$$

At step 530, the derivative of η(G) with respect to the parameter w_{f} is then evaluated by

$$\frac{\partial η ( 𝒢 )}{\partial {w}_{f}} = {\sum }_{G ∈ 𝒢} \frac{\partial η ( G )}{\partial {w}_{f}} \qquad ( 23 )$$

which is sum of the derivative of each individual graph (12).
At step 540, as the combined derivative has now been defined over the entire collection G, then once again a gradient ascent approach may be employed to determine link feature weights w_{f} based on the content and structure of the multiple websites 410, 420, 430.

As would be appreciated by those skilled in the art, the ability to use multiple websites or datasets is greatly simplified due to the linearity properties of the derivative, thereby greatly simplifying the computational requirements of determining the link feature weights w_{f} over these potentially extremely large combined data sets or training corpus. In this manner, use of a sufficient number of “training” websites will ensure that the link feature weights w_{f} that are determined will generalize to unseen websites with some level of statistical confidence as the structure of each of the individual websites is taken into account in this approach.

Referring back to FIG. 3, at step 310 it can be seen that it is first necessary to determine the web pages of interest in a web site. According to this second embodiment, this is then extended to now determining these web pages for multiple training websites. In one embodiment, this training data is collected by an exhaustive crawling strategy starting from the home pages of the training websites. For example, starting from
http://www.ibm.com

a generic crawler is configured to follow every link on every page within the ibm.com domain up to some predetermined maximum number of pages. This procedure is then repeated for the other training sites, and the crawled pages and links from each website are then stored persistently. In one embodiment, a human can then examine each page from the crawled training websites, and record those that match the target criteria—e.g., executive biography pages, product manager pages, etc. In another embodiment, where the training corpus is large, a page classifier is trained to automatically recognize the target pages and is then applied to each page in the training corpus. One example of such a classifier is described in detail in PCT Publication No. WO2006034544, entitled “Machine Learning System,” which is assigned to the assignee of the present invention and incorporated in its entirety by reference herein.

Once the training data has been collected, the link features chosen at step 320 must be extracted from all the links. As would be appreciated to those of ordinary skill in the art, the features should be extracted once and stored, so that the method for determining the link feature weights can be run several times with different parameter settings without requiring re-extraction of the features which can be a time-consuming process. As with most machine learning problems, some pruning of the features is likely to be required to reduce them to a manageable size and to avoid over fitting the training data.

In one embodiment, extremely large numbers of features are first generated (i.e., in the millions) from the training corpus and then pruned. Some example features could include every link text word, every phrase containing two words, all the character 4 grams from the destination URLs and so on. Then a minimum number of sites (e.g., 10) are selected and all the features that do not occur on at least that number of sites are pruned. This process prunes those features that are website specific and accordingly are unlikely to generalize across to unseen websites. These pruned automatically generated features can then be added to other features such as those determined by heuristic means.

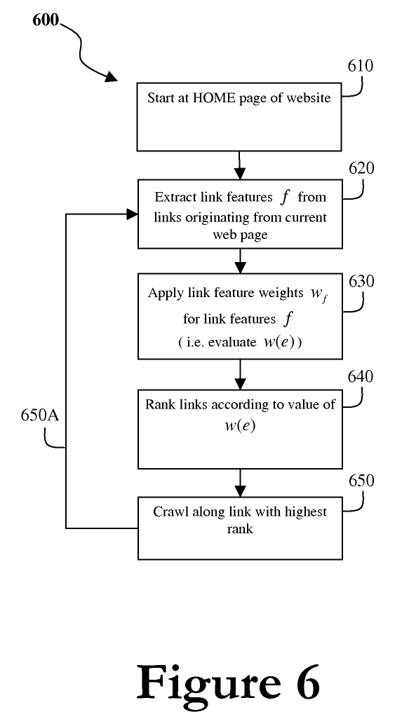

Referring now to FIG. 6, there is shown a flowchart of a method 600 for crawling linked elements (e.g., web pages) in an unseen data set (website) to find a subset having a predetermined characteristic according to a third embodiment of the present invention. Throughout the specification the term “unseen” relates to data sets or websites that are presented to the crawler that crawls on the basis of the link feature weights that are determined by for example the first and second embodiments of the present invention.

At step 610, the crawler starts at the HOME page of the website from which the information is to be extracted. At step 620, link features are then extracted from the links originating from the initial web page to the various linked web pages. This process is identical to the feature extraction process conducted on the training data sets when determining the link feature weights and in a similar manner this process is performed iteratively as the crawler crawls from web page to web page. These link features can also incorporate source page features as described earlier which relate to the source web page from which a link or links originate.

At step 630, the link feature weights that have been determined by the random walk and gradient ascent process are applied to the link features here, these link feature weights corresponding to the web pages of interest that are being sought by the crawler. In this embodiment, this involves calculating link ranking score w(e) for each link (see Equation (1)).

At step 640, the links originating from the page are ranked according to the link ranking score and at step 650 the crawler crawls along the outgoing link having the highest link ranking score to the next web page, at which stage 650A the link features f are extracted from the links originating from the new web page. Whilst in principle, the outgoing links from a page could be crawled according to the probabilities (3) (i.e., where the probability of selecting a link is monotonically related to its link ranking score), thereby reproducing the precise behavior of the method that was used to derive link feature weights w_{f} initially, it will be appreciated by those skilled in the art that employing the link ranking scores directly will still exploit link information to crawl rapidly to the target pages of interest.

Furthermore, instead of following links from web page to web page, the method may be modified to crawl all those outgoing links from a web page which have a relatively high link ranking score when compared to outgoing links originating from other pages in the website. This could also be modified so that the method crawls those links preferentially which have the highest link ranking score across the entire web site crawled thus far rather than those originating from the current web page being crawled. In this manner, a priority queue having a maximum size of all links from all pages crawled thus far can be maintained. Once the queue is full, only a link having a link ranking score above the lowest ranked link in the queue may be added by insertion into the queue at the appropriate queue position resulting in the lowest ranked link being deleted from the queue.

To prevent the crawling method from potentially becoming stuck in an area of a web site, a link can be chosen at random and the crawler then assess the link ranking scores of the links originating from the new random page.

In further embodiments directed to reducing the computational effort required, a list of all the pages crawled to date or a set of crawled elements within a website are maintained and the crawler is adapted not to follow a link to a page or element that has already been crawled. Furthermore, a cutoff or threshold can be applied to determine whether any links on a crawled page are likely candidates, by examining the w(e) or link ranking score of each link as given by (1).

If all the rank scores are low, then it is unlikely that any link will lead to a target page. In this third embodiment of the present invention directed to the crawling of web pages it was determined that a threshold of 0 resulted in computational savings without affecting the likelihood of finding those pages of interest. However, it is also important for the crawler to crawl a minimum number of pages, even if the links are low scoring, in case the original pages crawled contain no links of high link ranking scores. A minimum of 25 pages was found to work effectively for the executive biography crawler problem.

Further embodiments of the crawling method include segmenting the links to crawl based on their destination URL, and ensuring that each segment is crawled by choosing links from different segments on subsequent page crawls. The segmentation scheme may include grouping all destination URLs with the same path together and then ensuring all segments are then crawled, whilst still focusing the crawler on the highest scoring links. Furthermore the crawling step may be limited to crawl a predetermined number of elements depending on the information extraction task.

In further embodiments of the present invention, the crawled pages may be further processed by the trained classifier used to identify the web pages of interest. Any web page that is determined to be a page of interest by the classifier can then be stored for further processing, for example to extract all the executive biographies on the web page into a database.

One such method to extract structured information from a web page is described in detail in European Patent Publication No. EP1669896 entitled “A Machine Learning System for Extracting Structured Records From Web Pages and Other Text Sources,” which is assigned to the assignee of the present invention and incorporated in its entirety by reference herein. Any web page not of interest may then be discarded by the crawler (after extraction of its links), thereby conserving the amount of storage space required by the crawled pages.

The classification of web pages during the crawl as described above can also be advantageously used to further enhance the efficiency of the crawl. For example, the crawler can be terminated if a sufficiently long run of uninteresting pages as determined by the classifier is encountered.

Referring now back to FIG. 1, as referred to previously an iterative crawler as known in the prior art would need to exhaustively crawl all nineteen pages in web site 100 to be certain that it has found the two target web pages of interest which in this example are web pages 134, 135. However, a crawler that crawls in accordance with the present invention will seek to select the optimal link from each web page and hence only need to download five web pages in order to find the two target web pages 134, 135 by following the sequence:

110→130→133→134→134

The sequence of steps involved in following this path include:
selecting the link to 130 from amongst the 4 outgoing links of 110 (i.e., links 110→120, 110→130, 110→140, 110→150),
selecting the link to 133 from amongst the 4 outgoing links of 130 (i.e., links 130→120, 130→131, 130→132, 130→133)
once the crawler has downloaded web page 133, it would then traverse its two outgoing links to 134 and 135 (the pages of interest).

Even if the crawler is not able to select the most optimal link to follow, but is still able to do better than random guessing in its choice of links, it will still avoid downloading significant portions of the website. For example, a crawler that is unable to distinguish employment links from people links, but is able to reject all other kinds of links as unlikely to lead to target pages of interest, would need to download only seven of the nineteen pages in website 100 to be confident that it had found all target pages of interest. This can be seen as follows:

110→140→143→133→134→135

110→130→133→134→135

As would be apparent to those skilled in the art, by reducing the number of pages that must be downloaded to find the target pages of interest, the crawler thereby substantially reduces both the bandwidth and time taken to extract information from a website. In addition, if each page downloaded by the crawler is subject to additional processing, such as the automatic classification to determine if the page is of interest as described above, reducing the number of downloaded pages will also significantly reduce the computational resources required to process a website. Whilst in this illustrative example the crawler would save a total of fourteen pages by an optimal selection of the links to follow (and twelve pages with the less optimal behavior), it would be appreciated by those skilled in the art that for larger websites the savings will be correspondingly greater.

Accordingly, it was found that a crawler developed in accordance with the principles of the present invention was trained to follow links to executive biography pages on corporate websites using a training corpus consisting of around 100,000 pages from 1,000 websites, with around 10,000 link features after pruning, and 4,000 target (executive biography) pages. In comparison with a random crawler which spent approximately 4% of its time in the target pages, the resultant crawler spent approximately 50% of its time in the target pages when applied to unseen websites. Determining the link feature weights w_{f} on a PC class machine took approximately 24 hours.

The steps of a method or algorithm described in connection with the embodiments of the present invention disclosed herein may be embodied directly in hardware, in a software module executed by a processor, or in a combination of the two. The software module, may contain a number a number of source code or object code segments and may reside in any computer readable medium such as a RAM memory, flash memory, ROM memory, EPROM memory, registers, hard disk, a removable disk, a CD-ROM, a DVD-ROM or any other form of computer readable medium. In the alternative, the computer readable medium may be integral to the processor. The processor and the computer readable medium may reside in an ASIC.

It will be understood that the term “comprise” and any of its derivatives (e.g., comprises, comprising) as used in this specification is to be taken to be inclusive of features to which it refers, and is not meant to exclude the presence of any additional features unless otherwise stated or implied.

Although a number of embodiments of the present invention have been described in the foregoing detailed description, it will be understood that the invention is not limited to the embodiments disclosed, but is capable of numerous rearrangements, modifications and substitutions without departing from the scope of the invention as set forth and defined by the following claims.

We claim:

1. A method for determining link feature weights from a data set of linked elements, the link feature weights indicative of whether a link travels to a subset of the data set, the subset having a predetermined characteristic, the link feature weights corresponding to link features associated with links between the linked elements of the data set, the method comprising the steps of:
choosing the link features in accordance with the predetermined characteristic of the subset; and
determining the link feature weights based on evaluating a measure that the link travels towards the subset.

2. The method for determining link feature weights claim 1, wherein the step of determining the link feature weights based on evaluating a measure that the link travels towards the subset comprises the step of evaluating a random walk throughout the linked elements of the data set.

3. The method for determining link feature weights of claim 2, wherein the step of evaluating a random walk throughout the linked elements of the data set comprises estimating a proportion of time the random walk spends in the subset.

4. The method for determining link feature weights of claim 3, wherein the step of determining the link feature weights comprises the step of varying the link feature weights to optimize the measure to increase the proportion of time that the random walk spends in the subset.

5. The method for determining link feature weights of claim 4, wherein the step of varying the link feature weights to optimize the measure comprises the step of determining a derivative of the measure as a function of the link feature weights.

6. The method for determining link feature weights of claim 5, wherein the step of varying the link feature weights to optimize the measure comprises the step of adopting a gradient ascent approach.

7. The method for determining link feature weights of claim 2, wherein the step of evaluating of the random walk comprises the step of ensuring there is a unique stationary distribution over the linked elements of the linked data set.

8. The method for determining link feature weights of claim 7, wherein the step of evaluating of the random walk further comprises the step of increasing a convergence rate of the random walk to the unique stationary distribution.

9. The method for determining link feature weights of claim 8, wherein the step of increasing the convergence rate comprises the step of increasing the convergence rate by introducing a uniform jump probability between linked elements in the data set in the evaluating of the random walk.

10. The method for determining link feature weights of claim 9, wherein the link features further comprise source element features characteristic of a source element from which a link originates.

11. The method for determining link feature weights of claim 10, wherein the method further comprises the step of adding a free link to the linked elements of the data set, the free link originating from each of the linked elements and linking to a non-target element.

12. A method for determining link feature weights from a plurality of data sets of linked elements, the link feature weights indicative of whether a link travels to subsets in each of the plurality of data sets, the subsets each having a common predetermined characteristic, the link feature weights corresponding to link features associated with links between the linked elements of each of the plurality of data sets, the method comprising the steps of:
choosing the link features in accordance with the common predetermined characteristic of the subsets; and
determining the link feature weights based on a plurality of measures evaluated for each of the plurality of data sets, wherein an individual measure for an individual data set indicates that the link travels towards a corresponding subset in the individual data set.

13. The method for determining link feature weights of claim 12, wherein the step of determining the link feature weights based on a plurality of measures comprises the step of determining an individual measure based on evaluating a random walk throughout the linked elements of the individual data set.

14. The method for determining link feature weights of claim 13, wherein the step of evaluating a random walk throughout the linked elements of the individual data set comprises the step of estimating a proportion of time the random walk spends in the corresponding subset.

15. The method for determining link feature weights of claim 14, wherein the step of determining the link feature weights comprises the step of varying the link feature weights to optimize the plurality of measures to increase the proportion of time that the random walk spends in the corresponding subset of the individual data set.

16. The method for determining link feature weights of claim 15, wherein the step of varying the link feature weights to optimize the plurality of measures comprises the step of forming a combined measure as the sum of the plurality of measures.

17. The method for determining link feature weights of claim 16, wherein the step of varying the link feature weights to optimize the plurality of measures further comprises the step of determining a derivative of the combined measure as a function of the link feature weights.

18. A method for crawling linked elements in a data set to find a subset having a predetermined characteristic, the method comprising the steps of:
evaluating link feature weights corresponding to link features between linked elements in the data set, the link feature weights determined by evaluating a measure on at least one training data set that a link travels towards a corresponding subset having the predetermined characteristic in the at least one training data set;
ranking links between linked elements in the data set according to the evaluated link feature weights; and
crawling preferentially along the links of highest rank.

19. The method for crawling linked elements in a data set of claim 18, wherein the step of evaluating link feature weights corresponding to link features between linked elements in the data set, the link feature weights determined by evaluating a measure comprises the step of evaluating a random walk throughout linked elements in the at least one training data set.

20. The method for crawling linked elements in a data set of claim 18, wherein the step of ranking links comprises the step of determining a link ranking score proportional to the sum of the evaluated link feature weights.

21. The method for crawling linked elements in a data set of claim 18, wherein the method further comprises the step of recording a crawled set of elements corresponding to the elements crawled so far, and wherein the step of crawling further comprises the step of travelling only down links to destination elements that are not members of the crawled set.

22. The method for crawling linked elements in a data set of claim 18, wherein the method further comprises the step of terminating the crawling step after a predetermined number of elements have been crawled.

23. The method for crawling linked elements in a data set of claim 20, wherein the step of crawling comprises the step of traveling down a link having the highest link ranking score from outgoing links from a currently occupied element.

24. The method for crawling linked elements in a data set of claim 20, wherein the step of crawling comprises the step of traveling down a link having the highest ranking score amongst outgoing links from all previously crawled elements.

25. The method for crawling linked elements in a data set of claim 20, wherein the step of crawling further comprises the step of selecting a link non-uniformly at random from amongst outgoing links from all previously crawled elements, wherein the probability of selecting a link is monotonically related to its link ranking score.

26. The method for crawling linked elements in a data set of claim 18, wherein the method further comprises the step of periodically selecting a random link to be crawled.

27. The method for crawling linked elements in a data set of claim 18, wherein the method further comprises the step of applying an automatic classifier trained to recognize target elements of interest, and storing only those elements that are positively classified.

28. The method for crawling linked elements in a data set of claim 27, wherein the method further comprises the step of terminating the crawling step if a predetermined number of non-target elements are crawled sequentially.
